(19) United States
(12) Patent Application Publication
(10) Pub. No.: US 2010/0216528 A1
(43) Pub. Date: Aug. 26, 2010

(54) FOLDING MOBILE TERMINAL

(75) Inventors: Haruo Hayakawa, Yokohama-shi (JP); Kazunori Kono, Yokohama-shi (JP); Tatsuya Kato, Yokohama-shi (JP)

Correspondence Address: Seed Intellectual Property Law Group PLLC, 701 Fifth Avenue, Suite 5400, Seattle, WA, 98104, US

(73) Assignee: PANASONIC CORPORATION, Kadoma-shi, Osaka (JP)

(21) Appl. No.: 12/678,127

(22) PCT Filed: Sep. 8, 2008
(86) PCT No.: PCT/JP2008/002473

§ 371 Date: Mar. 12, 2010

(30) Foreign Application Priority Data
Sep. 14, 2007 (JP) 2007-238806
Jan. 30, 2008 (JP) 2008-018696

(51) Int. Cl. H04W 88/02

(52) U.S. Cl. 455/575.3

(57) ABSTRACT

In a portable telephone having a television receiving function that can be opened and closed in a longitudinal direction and in a transverse direction, a television broadcast can be seen in a horizontally long screen, however, a representation of an operating portion such as a ten-key remains to be a representation of the portable telephone. A key sheet (13) of the operating portion is stuck to a frame (6) sliding in a first casing (1). A cam (12) is provided in association with a first rotational axis (9). When a second casing (2) is opened in the longitudinal direction, the rotation of the first rotational axis (9) together with the second casing (2) is used to shift the frame (6) by the movement of the cam (12). The representation of the operating portion such as the ten-key is changed from the arrangement of figures for selecting a channel to the arrangement of figures for a telephone and the direction of the representation is also changed to that of a representation rotated by 90 degrees.

### TECHNICAL FIELD

The present invention relates to a folding mobile terminal in which two casings are connected together so as to freely open and close respectively in a longitudinal direction and a transverse direction.

### RELATED ART

In a foldable portable telephone having two casings connected to each other so as to be overlaid on each other, a user ordinarily uses the foldable portable telephone in such a manner that the user holds the first casing having an operating portion such as a ten-key by a hand and sees the second casing having a display portion.

However, recently, a portable telephone that receives and displays a television broadcast is put to practical use and starts to be popularized. In order to see a television broadcast screen that is horizontally long, the display portion is rotated by an angle of 90 degrees in the transverse direction so that the display portion may be more easily seen. Accordingly, a structure is proposed in which a second casing having a display portion is mechanically rotated on a rotational axis provided at an end portion in the transverse direction of the casing and a direction of the display portion is changed from the longitudinal direction to the transverse direction (for instance, see patent literature 1).

One example of a usually proposed foldable portable telephone is shown in FIGS. 24 to 26. A portable telephone 60 in FIG. 24 includes three casings of a first casing 61 having an operating portion 71, a second casing 62 having a display portion 72 and a connecting portion 63. Then, the connecting portion 63 is supported on a first rotational axis 61a provided in the first casing 61 so as to freely rotate in the direction shown by an arrow mark A. A second rotational axis 63a for connecting the connecting portion 63 to the second casing 62 is arranged in an end portion of a connecting surface to support the second casing 62 having the display portion 72 so as to feely rotate. Accordingly, in the portable telephone 60, under a state that the connecting portion 63 is erected vertically relative to the first casing 61 as shown in FIG. 25, the second casing 62 can be rotated on the second rotational axis 63a in the direction shown by an arrow mark B. Under this state, when the second casing 62 is allowed to fold together with the connecting portion 63 in the direction of an arrow mark C, the portable telephone 60 can be used in a form that the display portion 72 of the second casing 62 is opened in the transverse direction as shown in FIG. 26.

In the usual portable telephone 60, when the display portion 72 is changed from a state of the longitudinal direction to a state of the transverse direction, as shown in FIG. 24 and FIG. 25, three stages of rotating operations are carried out that include a rotating operation in the direction shown by the arrow mark A, a rotating operation in the direction shown by the arrow mark B and a rotating operation in the direction shown by the arrow mark C. Then, a mechanical movement of the casing by the rotating operations is detected to change a display direction of an image to be displayed in association with the movement of the casing.

In the usual portable telephone 60, the display portion 72 is set to a horizontally long direction so that a television broadcast may be seen. After the direction of the display portion 72 is set to the horizontally long form, an operation for selecting a program to be seen is subsequently carried out, However, the operating portion such as a ten-key maintains an arrangement of the portable telephone as it is and the direction of the ten-key maintains an original direction. When the display portion 72 is brought to what is called a transversely opened state, if the display of the operating portion maintains a longitudinal display, the operating portion is intuitively hardly operated. Especially, as the ten-key of the operating portion, figures from “1” to “10” are displayed, however, there is no display of a figure such as “11” or “12”. For instance, when a user tries to see a 12 channel, the user cannot understand which button is to be pushed.

In such a ease, when the second casing 62 is transversely opened to set the display portion 72 to the horizontally long form, the arrangement and direction of the operating portion such as the ten-key may be conveniently changed to an arrangement and direction to see the television broadcast. As a method for meeting that purpose, the operating portion may be supposed to have a form as a touch panel having a liquid crystal display and change the key arrangement and direction of the liquid crystal display every time the direction of the display portion 72 is changed. However, while the user sees the television broadcast, the liquid crystal display and a back light may not be turned on all the time. The liquid crystal display is turned off once, and then, the touch panel is touched once as required to turn on again the liquid crystal display, and then, select a channel (for instance, see patent literature 2).

Further, in the usual portable telephone 60 shown in FIGS. 24 to 26, the mechanical movement of the casing by the rotating operation in the direction shown by the arrow mark A, the rotating operation in the direction shown by the arrow mark B and the rotating operation in the direction shown by the arrow mark C is detected to change the display direction of the image to be displayed in association with the movement of the casing. Therefore, when the casing is opened or closed under a state that a power is not turned on, an optimum character input direction is not supposed to be displayed.

As other usual example, a key structure of an electronic device is known which includes a key top and a key function display portion that shows key function displays of respective keys so as to be externally recognizable, and is characterized in that the key function display portion can change its relative position to the key top and the externally recognizable key function displays are switched in accordance with the change of the relative position (for instance, patent literature 3).

FIG. 27 shows a schematic view of a front surface of the above-described usual electronic device, FIG. 28 portionly shows sections of a key top 91 and a key function display plate 84 taken along a line D-D in FIG. 27. In FIG. 28, a keyboard 90 slides rightward and leftward on a lower casing 81. When a conductor 93 provided at a right end of the keyboard 90 slides, the conductor is electrically conducted to two terminals 83 of the lower casing 81 to detect the rightward and leftward movement of the keyboard 90. When the keyboard 90 is set to one of the terminals, English characters can be inputted. When the keyboard 90 is set to the other of the terminals, Japanese characters can be inputted respectively.

As shown in FIG. 27, a key 91a of the keyboard 90 has a transparent portion 91b at a central portion. Further, as shown in FIG. 28, a lower surface of the key 91a comes into contact with an upper surface 84a of the key function display plate 84 so as to freely slide. The key function display plate 84 has a lower end vertically fixed to the lower casing 81 of a main body of the electronic device 80, an intermediate portion bent stepwise and the upper surface 84a which is horizontal and on which characters are printed. Here, the upper surface 84a includes a Japanese character representation and an English character representation that are arranged right and left in parallel with a prescribed width spaced between them. The above-described prescribed width is equal to a slide stroke of the keyboard 90. Further, the size of the transparent portion 91 b is slightly larger than the character representation of the key function display plate 84 or so and the two characters are not looked through from the transparent portion 91b. When the keyboard 90 is allowed to come near to the right or the left in FIG. 27, the contents of the representation looked through from the transparent portion 91b are switched to the Japanese character representation or the English character representation. In the above-described key structure, even when the power of the main body of the electronic device 80 is not turned on, the contents of the representation of the key function display plate can be switched.

### CITATION LIST

### Patent Literature

Patent literature 1: JP-A-2006-22899
Patent literature 2: JP-A-2001-296958
Patent literature 3: JP-A-2002-7034

### SUMMARY OF THE INVENTION

### Technical Problems

The present invention relates to a folding mobile terminal having two rotational axes and connected so as to freely open and close in a longitudinal direction and in a transverse direction, such as a portable telephone, a game machine or a PDA (Personal Digital Assistants) having a television receiving function. It is a first object of the invention to change characters printed on an operating portion such as a ten-key so as to meet the direction of a display device such as a liquid crystal display when a second casing is opened from its folded state by rotating the rotational axis of a connecting portion.

It is a second object of the invention to realize a maneuverable potable terminal device that can change characters printed on an operating portion such as a ten-key so as to meet the direction of a display device such as a liquid crystal display even when a power is not turned on.

Further, it is a third object of the invention to change characters so as to meet the direction of a display device by opening and closing a second casing to a first casing without an intended operation by a user.

### Solution to the Problems

A folding mobile terminal according to the present invention comprises a first casing provided with an operating portion and a second casing provided with a display, the first and the second casings connected through a connecting portion, characterized in that the connecting portion comprises: a first rotational axis opening and closing the second casing in a longitudinal direction relative to the first casing; and a second rotational axis opening and closing the second casing in a transverse direction relative to the first casing, and the operating portion comprises; a key sheet printed with contents of respective operation keys, wherein the key sheet slides while following the rotation of the first rotational axis and the key sheet does not follow the rotation of the second rotational axis.

A folding mobile terminal of the present invention comprises a first casing provided with an operating portion and a second casing provided with a display, the first and the second casings connected through a connecting portion, characterized in that: the connecting portion comprises: a first rotational axis opening and closing the second casing in a longitudinal direction relative to the first casing; a second rotational axis opening and closing the second casing in a transverse direction relative to the first casing; and a cam attached to the first rotational axis, the first casing comprises inside thereof: a key sheet printed with contents of operation keys; and a follower member fixed to the key sheet and following the rotation of the cam, wherein the follower member and the key sheet slide while following the cam when the first rotational axis rotates.

In the above-described structure, the folding mobile terminal is the connecting portion on which the cam is arranged in the longitudinal direction; the follower member abuts on the cam while the first casing and the second casing are in a closed state; and the follower member moves toward the connecting portion while following the cam by urging of the compressed spring when the cam rotates in accordance with the rotation of the first rotational axis from the closed state.

In the above-described structure, a folding mobile terminal is characterized in that one end of the compressed spring is attached to the follower member and the other end is fixed to a holder provided in the first casing.

In the above-described structure, a mask sheet overlapping a printed surface side of the key sheet, wherein a first character group is printed on the printed surface of the key sheet in the longitudinal direction of the first casing and a second character group is printed on the printed surface of the key sheet in the transverse direction of the first casing, the mask sheet forms a plurality of transparent display windows through which either the first character group or the second character group is externally and visually recognizable when the slide sheet slides, the first character group overlaps the display windows while the second casing is in a opened state relative to the first casing in the first direction, the second character group overlaps on the display windows while the second casing is in a opened state or in a closed state relative to the first casing in the second direction.

A folding mobile terminal of the present invention comprises a first casing provided with an operating portion and a second casing provided with a display, the first and the second casings connected through a connecting portion, characterized in that: the connecting portion comprises: a first rotational axis for rotating the second casing relative to the first casing in a first direction; and a second rotational axis for rotating the second casing relative to the first casing in a second direction perpendicular to the first direction; and the operating portion comprises: a key sheet printed with characters showing functions of respective keys; a key top sheet disposed on a printed surface side of the key sheet; a frame surrounding the key sheet; and a pusher sheet disposed on a back surface side of the printed surface of the key sheet and fixed to the frame, wherein the key sheet is fixed to a connecting member which interlocks with the rotation of the first rotational axis, and the key sheet slides inside of the frame in accordance with the rotation of the first rotational axis.

In the above-described structure, a folding mobile terminal is characterized in that the first direction is a longitudinal direction in which the second casing is opened relative to the first casing, and the second direction is a transverse direction in which the second casing is opened relative to the first casing.

In the above-described structure, a folding mobile terminal is characterized in that the pusher sheet is stuck and fixed to the frame.

In the above-described structure, a folding mobile terminal is characterized in that the key top sheet is fixed to the frame.

In the above-described structure, a folding mobile terminal is characterized in that the connecting member comprises: a protrusion fixed to the first rotational axis, which rotates in accordance with the rotation of the first rotational axis; and a follower member fixed at one end thereof to the key sheet, which follows the protrusion at the other end thereof when the first rotational axis rotates in a predetermined angle, wherein when the second casing rotates about the first rotational axis for a closing direction, and the key sheet slides by the rotation of the protrusion so as to push the other end of the follower member.

In the above-described structure, the key sheet is printed with a first character group in a first direction and with a second character group in a second direction perpendicular to the first direction; the key top sheet forms a plurality of transparent display windows through which either the first character group or the second character group is externally and visually recognizable, when the key sheet slides; the first character group overlaps on the display window when the second casing is in an opened state in the first direction relative to the first casing; and the second character group overlaps on the display window when the second casing is in an opened state in the second direction relative to the first casing or in a closed state.

In the above-described structure, a folding mobile terminal is characterized in that the characters displayed on the key sheet in two different directions are alternately printed.

In the above-described structure, a folding mobile terminal further includes a radio communication unit and a television broadcast receiving unit, wherein characters for the radio communication are printed as the first character group; and character for the television broadcast receiving are printed as the second character group.

In the above-described structure, a folding mobile terminal further includes a pressing unit, whose one end is fixed to the follower member and the other end is fixed to a supporting portion provided inside of the first casing, wherein the follower member is pressed toward the connecting portion in the first direction by the pressing unit; the follower member abuts on the protrusion when the first casing and the second casing are En the closed state; the follower member moves toward the connecting portion following the protrusion under the pressure from the pressing unit when the protrusion rotates in accordance with the rotation of the first rotational axis from the closed state.

In the above-described structure, a folding mobile terminal is characterized in that the pressing unit is a torsion coil spring.

In the above-described structure, a folding mobile terminal is characterized in that the pressing unit is a compressed spring.

In the above-described structure, a folding mobile terminal is characterized in that in the holder, a stopper is formed on the holder in a direction of the follower member movement; and the follower member abuts on the stopper when the follower member moves in a predetermined amount.

In the above-described structure, a folding mobile terminal is characterized in that a plurality of micro protrusions are formed on the printed surface of the key sheet.

### Advantageous Effects of the Invention

According to the present invention, in the folding mobile terminal such as a portable telephone, a game machine or a PDA having a television receiving function that has two rotational axes and formed so as to freely open and close in a longitudinal direction and in a transverse direction, when a second casing is opened from its folded state by rotating the rotational axis of a connecting portion, characters printed on an operating portion such as a ten-key can be changed so as to meet the direction of a display device such as a liquid crystal display.

Further, since a changing operation is mechanically carried out, even if the casing is opened and closed when a power is not turned on in the portable terminal device, the characters printed on the operating portion such as the ten-key can be changed so as to meet the direction of the display device such as the liquid crystal.

Further, since the operating portion has a sealed structure by a key top sheet, a frame and a pusher sheet, the operating portion is excellent in its dust-proof or water-proof function.

### BRIEF DESCRIPTION OF THE DRAWINGS

FIG. 1 is a perspective view showing a state that a casing of a portable telephone according to a first exemplary embodiment of the present invention is opened in a longitudinal direction,

FIG. 2 is a perspective view showing a state that the casing of the portable telephone according to the first exemplary embodiment of the present invention is opened in a transverse direction.

FIG. 3 is an exploded perspective view of main portions of an operating portion of the portable telephone according to the first exemplary embodiment of the present invention.

FIG. 4 is a partial sectional view when the portable telephone according to the first exemplary embodiment of the present invention is closed.

FIG. 5A is a partial sectional view showing a state that the casing of the portable telephone according to the first exemplary embodiment of the present invention is opened in the transverse direction and FIG. 5B is a plan view showing a state that the casing of the portable telephone according to the first exemplary embodiment of the present invention is opened in the transverse direction.

FIG. 6A is a partial sectional view showing a state that the casing of the portable telephone according to the first exemplary embodiment of the present invention is opened in the longitudinal direction and FIG. 68 is a partial sectional view showing a state that the casing of the portable telephone according to the first exemplary embodiment of the present invention is opened in the longitudinal direction.

FIG. 7 is a plan view showing a state that the casing of the portable telephone according to the first exemplary embodiment of the present invention is opened in the longitudinal direction.

FIG. 8 is a sectional view of a casing of a portable telephone according to a modified example of the first exemplary embodiment.

FIG. 9 is a perspective view showing a state that a casing of a portable telephone according to a second exemplary embodiment of the present invention is opened in a first direction.

FIG. 10 is a perspective view showing a state that the casing of the portable telephone according to the second exemplary embodiment of the present invention is opened in a second direction.

FIG. 11 is an exploded perspective view of main portions of an operating portion of the portable telephone according to the second exemplary embodiment of the present invention,

FIG. 12 is a perspective view showing a structure of a portion related to a key sheet in the second exemplary embodiment of the present invention.

FIG. 13 is a partial sectional view showing the structure of the portion related to the key sheet in the second exemplary embodiment of the present invention.

FIG. 14A is a partial sectional view showing a state that the casing of the portable telephone according to the second exemplary embodiment of the present invention is opened in the first direction and FIG. 14B is a partial sectional view showing a state that the casing of the portable telephone according to the second exemplary embodiment of the present invention is opened in the first direction.

FIG. 15 is a plan view showing a state that the casing of the portable telephone according to the second exemplary embodiment of the present invention is opened in the first direction.

FIG. 16 is a partial sectional view showing a state when the portable telephone according to the second exemplary embodiment of the present invention is closed.

FIG. 17A is a partial sectional view showing a state that the casing of the portable telephone according to the second exemplary embodiment is opened in the second direction and FIG. 17B is a plan view showing a state that the casing of the portable telephone according to the second exemplary embodiment is opened in the second direction.

FIG. 18 is a perspective view showing a structure of a portion related to a key sheet in the second exemplary embodiment of the present invention.

FIG. 19 is a partial sectional view showing the structure of the portion related to the key sheet in the second exemplary embodiment of the present invention.

FIG. 20A is a partial sectional view showing a state that the casing of the portable telephone according to the second exemplary embodiment of the present invention is opened in the first direction, FIG. 20B is a partial sectional view showing a state that the casing of the portable telephone according to the second exemplary embodiment of the present invention is opened in the first direction and FIG. 20C is a partial sectional view showing a state that the casing of the portable telephone according to the second exemplary embodiment of the present invention is closed.

FIG. 21A is a partial sectional view showing a state that a casing of a portable telephone according to a third exemplary embodiment of the present invention is opened in a first direction and FIG. 21B is a partial sectional view showing a state that the casing of the portable telephone according to the third exemplary embodiment of the present invention is opened in the first direction.

FIG. 22 is a perspective view showing a structure of a portion related to a key sheet in a fourth exemplary embodiment of the present invention.

FIG. 23 is a partial sectional view showing the structure of the portion related to the key sheet in the fourth exemplary embodiment of the present invention.

FIG. 24 is a perspective view showing a state that a second casing of a usual portable telephone is opened in a longitudinal direction.

FIG. 25 is a perspective view showing a state that the second casing of the usual portable telephone is opened in the longitudinal direction, and further, the second casing is rotated.

FIG. 26 is a perspective view showing a state that the second casing of the usual portable telephone is opened together with a connecting portion in the longitudinal direction, the second casing is rotated relative to the connecting portion, and then, the connecting portion is closed.

FIG. 27 is a plan view of a usual electronic device.

FIG. 28 is a partial sectional view of the usual electronic device.

### DESCRIPTION OF REFERENCE NUMERALS AND SIGNS

1, 1A: first casing
2, 2A: second casing
3, 3A: connecting portion
4, 4A: printed circuit board
5, 5A: diaphragm
6, 6A: frame
7, 7A: follower member
8: compressed spring holder
8A: torsion coil spring holder
9, 9A: first rotational axis
10,10A: second rotational axis
11: compressed spring
11A: torsion coil spring
12: cam
12A: protruding portion
13, 13A: key sheet
16A: key top sheet
19A: pusher sheet
51A: operating portion

### DESCRIPTION OF EMBODIMENTS

### First Exemplary Embodiment

In a first exemplary embodiment of the present invention, a problem is solved by using an operation that a connecting portion as a third casing for connecting a first casing to a second casing is opened or closed relative to the first casing having an operating portion depending on whether the second casing is opened in a longitudinal direction or a transverse direction when the second casing is opened relative to the first casing.

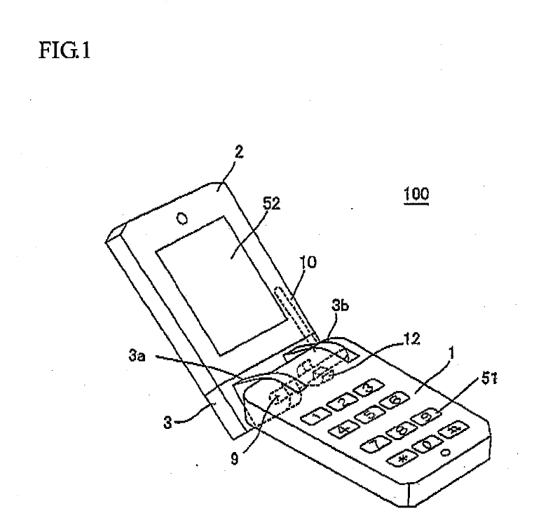

FIG. 1 is a perspective view showing a state that a second casing 2 of a foldable portable telephone 100 according to a first exemplary embodiment of the present invention is opened in a longitudinal direction. A first casing 1 having an operating portion 51 supports a first rotational axis 9 so as to freely rotate by a bearing portion not shown in the drawing. A connecting portion 3 fixes the first rotational axis 9 integrally to the connecting portion 3 by shaft holders 3a and 3b. Further, a cam 12 shown by a broken line can be allowed to interlock with the first rotational axis 9. Accordingly, the connecting portion 3, the first rotational axis 9 and the cam 12 rotate as integral portions. In one corner of the connecting portion 3, a second rotational axis 10 shown by a broken line is provided so as to be orthogonal to the first rotational axis 9. To the second rotational axis 10, the second casing 2 is attached so as to freely rotate. In the second casing 2, a display portion 52 is provided.

In such a way, in the foldable portable telephone 100, when the second casing 2 is opened in a longitudinal direction relative to the first casing 1, figures of a ten-key of the operating portion 51 are displayed in a ten-key arrangement for a telephone determined by a standard and in the direction for the longitudinal direction so as to be used as the telephone.

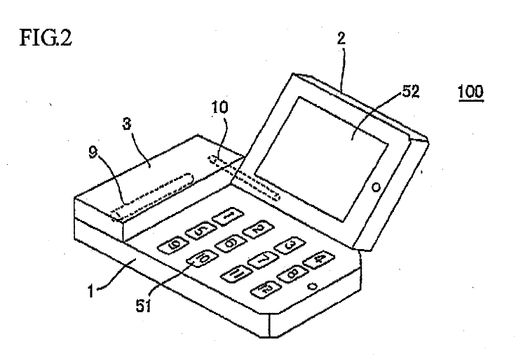

In FIG. 2, a state is shown as a perspective view that the second casing 2 of the foldable portable telephone 100 according to the first exemplary embodiment of the present invention is opened in a transverse direction. The arrangement of respective portions is the same as that of FIG. 1, however, the second casing 2 is rotated on the second rotational axis 10 from its closed state and opened in the transverse direction relative to the first casing 1. The connecting portion 3 is closed relative to the first casing 1. At this time, for the figures of the ten-key of the operating portion 51, “1”, “2”, “3” and “4” are arranged from the left in a first row so that the figures may be easily used for a television receiver. In a second row, “5”, “6”, “7” and “8” are arranged from the left. Then, in a third row, “9”, “10”, “11” and “12” are arranged. The directions of the figures are also displayed in directions meeting the transverse direction of the casing.

In the foldable portable telephone 100, when the second casing 2 is opened in the longitudinal direction and in the transverse direction respectively relative to the first casing 1, printed characters of the operating portion 51 are arranged so as to be seen in directions suitable for the direction of a display of a liquid crystal display portion. Now, a detail of a structure thereof will be described below.

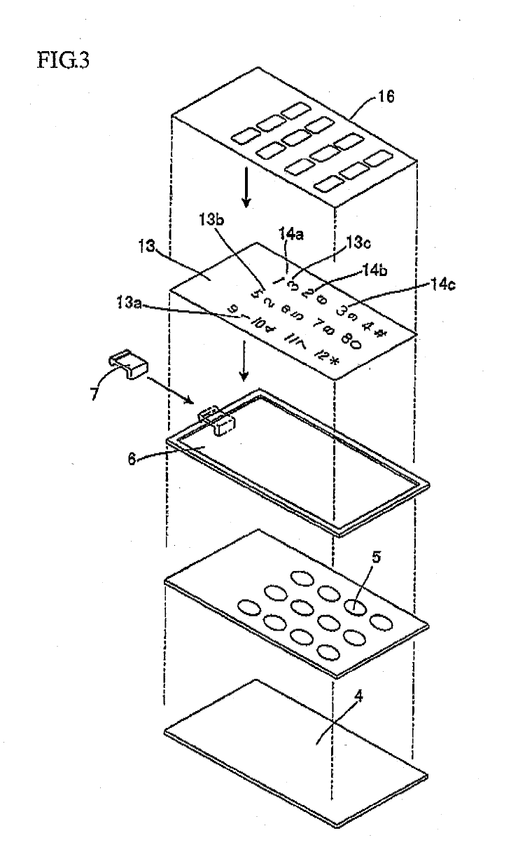

FIG. 3 is an exploded perspective view of main portions of the operating portion 51. As shown in FIG. 3, a key sheet 13 on which the contents of keys such as the figures is fixed to a frame 6 provided on a back surface of a printing surface of the key sheet 13. In the key sheet 13, the figures from “1” to “10” for the ten-key are arranged and printed in such a way as shown by 13a, 13b and 13c. Further, such figures for television channels as 14a, 14b and 14c are arranged and printed in such a way as to stride over the figures for the ten-key. The directions of the figures for the ten-key (a first group of printed characters) are printed upward and downward in the longitudinal direction of the second casing 2. The figures for the television channels (a second group of printed characters) are printed in the transverse direction by changing the longitudinal direction by an angle of 90 degrees.

In the present exemplary embodiment, the key sheet 13 is stuck to an upper surface of the frame 6 to form what is called a key sheet. However, the characters may be written on the frame 6 itself by printing them to form a key sheet.

On the printing surface of the figures of the key sheet 13, a mask sheet 16 made of a plastic member is overlaid or overlapped. On the mask sheet 16, transparent portions are formed with the sizes of the printed characters of the first group of printed characters prints of the first group of printed characters or the second group of printed characters in the key sheet 13 are seen, remaining portions are formed as opaque portions. The mask sheet 16 is stuck to the casing.

To the frame 6 provided in the back surface of the printing surface of the key sheet 13, a follower member 7 is integrally fixed. The frame member is incorporated in the first casing 1 as one portions to which the follower member 7 is integrally fixed. The follower member 7 moves following a cam attached to the first rotational axis when the first rotational axis moves at a prescribed angle or more relative to the cam. Accordingly, the follower member 7 and the frame 6 and the key sheet 13 stuck to the frame 6 integrally slide following the rotation of the first rotational axis. A detail of a sliding shift will be described below.

Further, in the frame 6, in an opposite side to a side to which the key sheet 13 is stuck, diaphragms 5 and a key circuit board 4 are arranged. The number of the diaphragms 5 smaller than that of the figures and characters printed on the key sheet 13 are arranged, When the diaphragm 5 is pressed from an upper portion, a central portion is depressed and a contact provided at a position overlapped on the central portion comes into contact with a contact circuit for a key on the key circuit board 4 to be electrically conducted thereto so that a pressing operation is sensed.

When the surface of the frame 6 is painted in white color or the frame 6 itself is formed with a white material, since the characters of the key sheet 13 rise to the surface in white so that the characters are clearly seen or effectively easily seen.

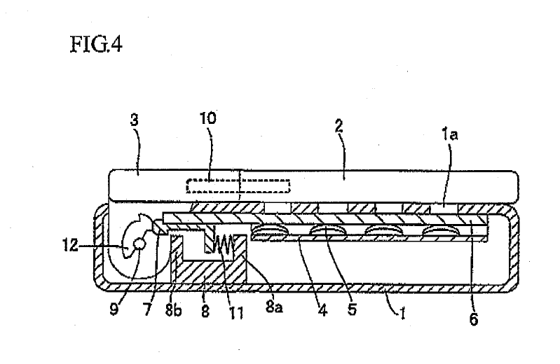

FIG. 4 shows a partial sectional view of the foldable portable telephone 100 according to the first exemplary embodiment of the present invention. FIG. 4 shows a state that the second casing 2 is closed together with the connecting portion 3 relative to the first casing 1 and shows an inner portion of the first casing I in section. The foldable portable telephone 100 changes the arrangement of keys and the direction of the display of the operating portion depending on the movement of the connecting portion 3 relative to the first casing 1. In the first casing I, the printed circuit board 4 is provided that is supported by a support portion not shown in the drawing. On the printed circuit board 4, are arranged the diaphragms 5 the number of which is smaller than that of the figures and characters printed on the key sheet 13. When the diaphragms 5 are pressed from the upper portion, the central portions are depressed and contacts not shown in the drawing that are provided in the central portions come into contact with the contact circuit for keys on the printed circuit board 4 to be electrically co conducted thereto, so that the diaphragms 5 sense the pressing operation. Between the diaphragms 5 and the key sheet 13, the frame 6 is supported so as to slide (rightward and leftward in the drawing).

In the first casing 1, a compressed spring holder 8 is provided to support a compressed spring 11 by a spring holder 8a. When the first rotational axis is rotated by a prescribed angle or more, an end face of the follower member 7 fixed to the frame 6 is pressed in the rotating direction of the first rotational axis in the first casing 1. The frame 6 is apt to move leftward in the drawing by the force of the compressed spring 11. In a side of the compressed spring holder 8 opposite to the spring holder 8a, a stopper portion 8b protrudes that stops the movement of the frame 6 in the leftward direction in the drawing. When there is not any other member for stopping the movement of the frame, the frame 6 moves toward the connecting portion in the casing until the frame abuts on the stopper portion 8b.

The cam 12 is attached to the first rotational axis 9. The cam 12 abuts on an end of the follower member 7 fixed to the frame 6. When the first rotational axis 9 rotates by a prescribed angle or more, the follower member 7 moves together with the frame 6 following the cam 12.

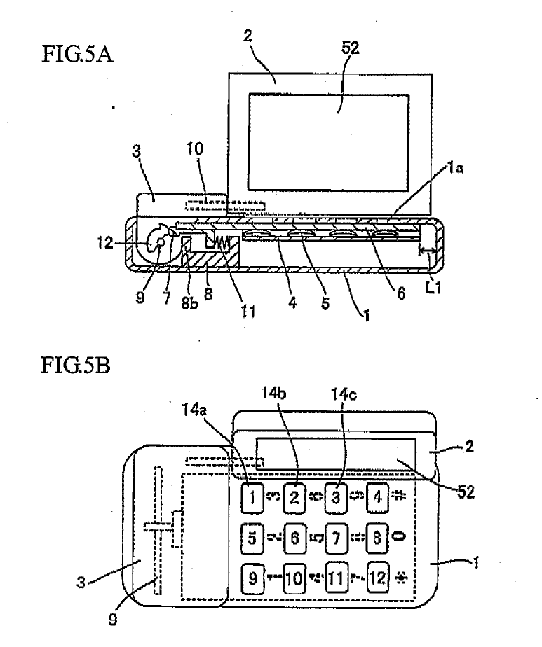

FIG. 5A shows a state that the second casing 2 is opened in the transverse direction, The first casing 1 is shown in section, The connecting portion 3 remains to be closed relative to the first casing 1, however, the second casing 2 is rotated on the second rotational axis 10 to show the display portion 52. Here, since the connecting portion 3 remains to be closed relative to the first casing 1, the first rotational axis 9 does not rotate. Namely, the cam 12 does not rotate and the frame 6 is maintained in the same state as that when the second casing 2 is closed as shown in FIG. 4.

FIG. 5B shows a plan view of the foldable portable telephone 100 when the second casing 2 is opened in the transverse direction. Since the second casing 2 is opened, for operating buttons, the figures can be seen from transparent windows 1a of the first casing 1. In FIG. 5B, the figures from “1” to “12” for the television channels are seen in such a way that “1”, “2”, “3” and “4” are arranged in a first stage on the direction of characters. In a second stage, “5”, “6”, “7” and “8” are arranged. In a third stage, “9”, “10”, “11” and “12” are arranged. Consequently, when the display portion 52 of the foldable portable telephone 100 is set to a horizontally long form to see a television broadcast, a user can push any of channels of “1” to “12” without a hesitation.

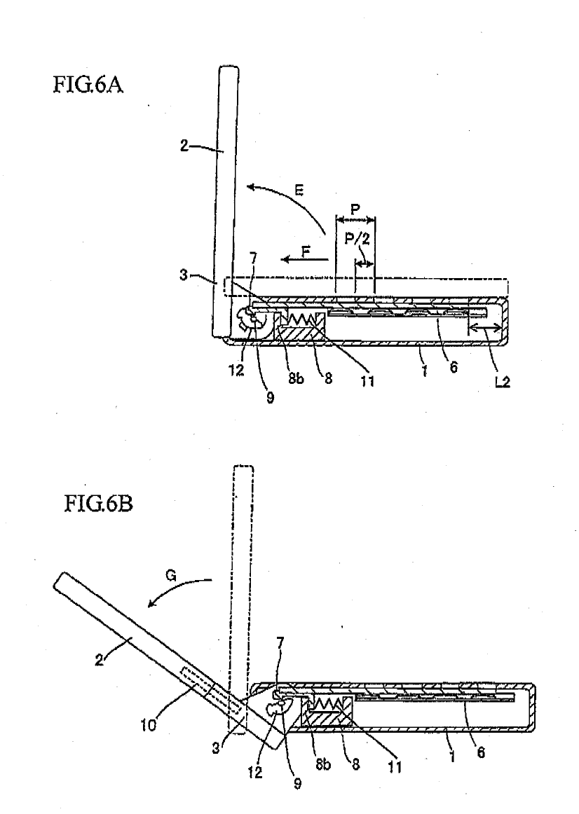

In FIG. 6A, a state is shown that the second casing 2 is opened by 90 degrees from a closed state in the longitudinal direction. The first casing 1 is shown in section. The connecting portion 3 is opened together with the second casing 2 in a direction shown by an arrow mark E relative to the first casing I. When the connecting portion 3 is opened, the first rotational axis 9 fixed integrally with the connecting portion 3 is also rotated in the direction shown by the arrow mark E. When the first rotational axis 9 is rotated, the cam 12 interlocks therewith to rotate. When the cam 12 is rotated in the direction shown by the arrow mark E, the follower member 7 is moved leftward in the drawing, that is, in the direction shown by an arrow mark F by an expanding force of the compressed spring 11. The follower member 7 is continuously moved leftward in the drawing to abut and stop on the stopper portion 8b formed to protrude in the compressed spring holder 8.

An amount of movement of the follower member 7 is set to an amount half as long as one pitch between adjacent windows I a of the first casing 1. Namely, when the one pitch is supposed to be “P”, the follower member 7 is moved leftward by “P/2” and the frame 6 to which the follower member 7 is fixed is also moved leftward by “P/2”.

In FIG. 6B, a partial sectional view is shown that illustrates a state when the second casing 2 is completely opened from a position at an angle of 90 degrees in the longitudinal direction. Since the follower member 7 abuts on the stopper portion 8b protruding in the holder 8 of the compressed spring 11, its movement is stopped, however, the connecting portion 3, the first rotational axis 9 and the cam 12 can be further opened together with the second casing 2 in the direction shown by an arrow mark G, and stop at a prescribed angle suitable for reading a speech or an electronic mail as the portable telephone.

In the foldable portable telephone 100 of the present invention, when the second casing 2 is opened at an angle of 90 degrees in the longitudinal direction, the movement of the follower member 7 by the cam 12 is completed. As a result, when the second casing 2 is opened at an angle of 90 degrees in the longitudinal direction, the arrangement of the keys and the direction of the display of the operating portion 5 are changed to contents shown when the second casing 2 is opened in the longitudinal direction.

An operator of the foldable portable telephone 100 is ordinarily supposed to see the operating portion 51 after the second casing 2 is completely opened further in the direction shown by the arrow mark G. Therefore, when the operator of the foldable portable telephone 100 opens the second casing 2 and directs his or her eyes to the operating portion, the arrangement of the keys and the direction of the display have been already changed. When a state is seen that the positions of the characters are gradually changed as the second casing 2 is gradually opened or closed, an outward appearance is not good. However, in the foldable portable telephone 100 of the present invention, in an initial state that the second casing 2 begins to be opened, namely, an opening angle is located within a prescribed angle, the change of the arrangement of the keys and the direction of the display is completed so that the outward appearance is not deteriorated.

Accordingly, in the present exemplary embodiment, an example is described in which when the second casing 2 is opened at the angle of 90 degrees, the arrangement of the keys and the direction of the display are completely changed. However, in the initial stage that the second casing 2 begins to be opened, an angle at which the change is completed is not limited to 90 degrees.

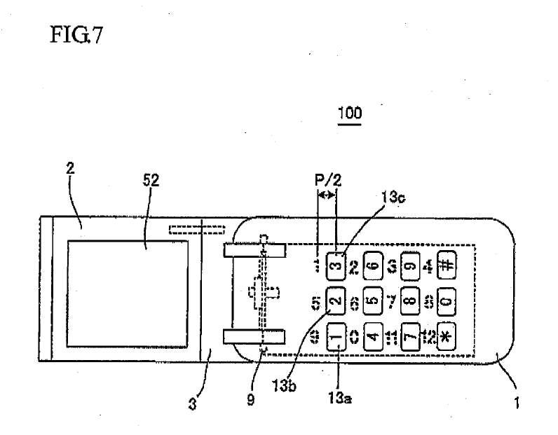

FIG. 7 shows a plan view of the foldable portable telephone 100 when the second casing 2 is completely opened in the longitudinal direction, Since the second casing 2 is opened together with the connecting portion 3, for the operating buttons, the figures can be seen from the transparent windows 1a of the first casing 1, In FIG. 7, the figures are seen in such a way that “1”, “2” and “3” are arranged in a first stage on the direction of characters for a telephone. In a second stage, “4”, “5”, and “6” are arranged. Then, in a third stage, “7”, “8” and “9” are arranged. In a fourth stage, “*”, “0” and “#” are arranged. Consequently, when the display portion 52 of the foldable portable telephone 100 is set to a longitudinally long form, the operator can push ten-key buttons as the arrangement of the figures of the telephone without a hesitation.

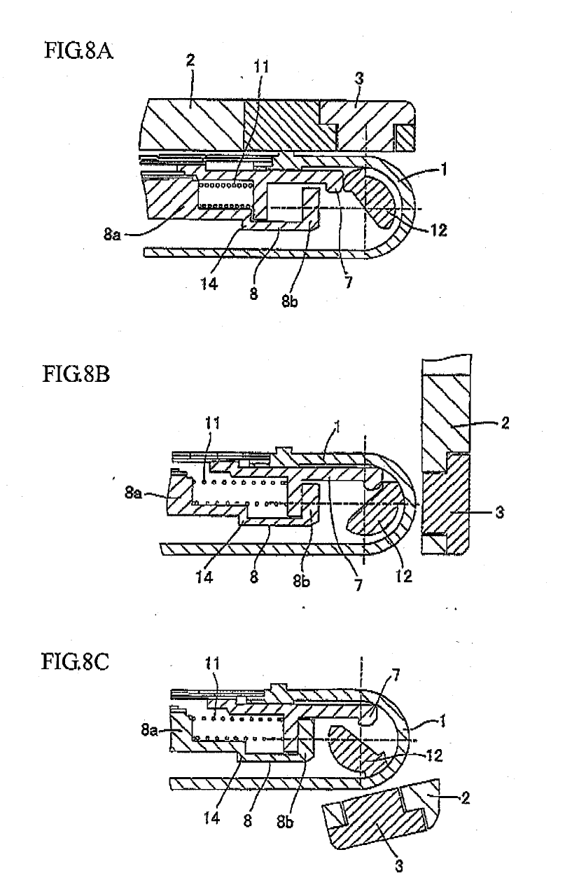

In order to prevent the position of a slider plate 6 from being unstable due to an unevenness in rotation of the cam 12 under a state that the second casing 2 and the connecting portion 3 are closed relative to the first casing 1 as shown in FIG. 8A, a second stopper 14 that determines the position of the slider plate 6 may be provided. In FIG. 88, a sectional view is shown which illustrates a state that the second casing 2 and the connecting portion 3 are opened at an angle of 90 degrees, and in FIG. 8C, a sectional view is shown that illustrates a state that the second casing 2 and the connecting portion 3 are completely opened when the second stopper portion 14 is provided.

Further, in the first exemplary embodiment, a case is described that the cam 12 is fixed to the first rotational axis 9. However, in a structure that the rotation of the first rotational axis 9 interlocks with and is transmitted to the cam 12, any other Structure may be used. For instance, another shaft may be provided between the first rotational axis 9 and an axis of the cam 12 to allow the first rotational axis 9 and the cam 12 to interlock therewith. Thus, the position of the axis of the cam 12 may be arbitrarily set.

As described above, in a two-shaft rotating type portable telephone, when the second casing is opened from its folded state, the contents of the display and the direction of the display of the operating portion can be properly changed depending on whether the second casing is opened in the longitudinal direction or in the transverse direction,

Further, the rotating movement of the connecting portion 3 as the third casing relative to the first casing I is taken as the movement of the cam 12 to slide the frame 6 to which the follower member is fixed, so that the contents of the display and the direction of the display of the operating portion are mechanically changed. Therefore, even when a power is not turned on in a portable terminal device, the contents of the display and the direction of the display of the operating portion can be assuredly changed.

As described above, in the present invention, is explained the portable telephone having a television receiving unit as one of the portable terminal device. In a portable telephone having a function of an electronic desk calculator, when the portable telephone is opened in a transverse direction, the arrangement of keys may be changed to the arrangement of keys for the calculator so that the portable telephone may be used as the electronic desk calculator. In addition thereto, characters displayed in two different directions may be alternately arranged. Thus, a game machine or other various kinds of portable terminal devices may be met.

### Second Exemplary Embodiment

In a second exemplary embodiment of the present invention, a problem is solved by using an operation that a connecting portion as a third casing for connecting a first casing to a second casing is opened or remains to be closed relative to the first casing having an operating portion depending on whether the second casing is opened in a first direction (a first direction of a casing) or in a second direction (a second direction of a casing).

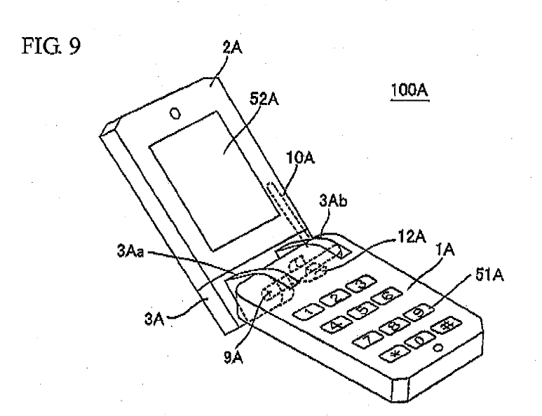

FIG. 9 is a perspective view showing a state that a second casing 2A of a foldable portable telephone 100A according to the second exemplary embodiment of the present invention is opened in a first direction. A first casing I A having an operating portion 51 A supports a first rotational axis 9A so as to freely rotate by a bearing portion not shown in the drawing. A connecting portion 3A fixes the first rotational axis 9A integrally to the connecting portion 3A by shaft holders 3Aa and 3Ab. Further, a protruding portion 12A shown by a broken line is fixed to the first rotational axis 9A. Accordingly, the connecting portion 3A, the first rotational axis 9A and the protruding portion 12A rotate as integral portions. In one corner of the connecting portion 3A, a second rotational axis 10A shown by a broken line is provided so as to be orthogonal to the first• rotational axis 9A. To the second rotational axis 10A, the second casing 2A is attached so as to freely rotate. In the second casing 2A, a display portion 52A is provided.

In such a way, in the foldable portable telephone 100A, when the second casing 2A is opened in the first direction relative to the first casing 1A, figures of a ten-key of the operating portion 51A are displayed in a ten-key arrangement for a telephone determined by a standard and in the first direction as an upward and downward direction so as to be used for the telephone.

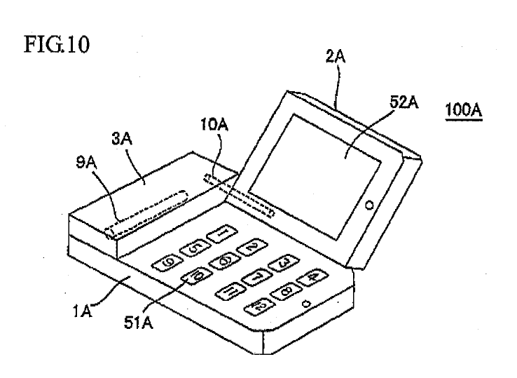

In FIG. 10, a state is shown as a perspective view that the second casing 2A of the foldable portable telephone 100A according to the second exemplary embodiment of the present invention is opened in a second direction. The arrangement of respective portions is the same as that of FIG. 9, however, the second casing 2A is rotated on the second rotational axis 10A from its closed state and the second casing 2A is opened in the second direction relative to the first casing 1. The connecting portion 3A is closed relative to the first casing 1. At this time, for the figures of the ten-key of the operating portion 51A, “1”, “2”, “3” and “4” are arranged from the left in a first row so that the figures may be easily used for a television receiver. In a second row, “5”, “6”, “7” and “8” are arranged from the left. Then, in a third row, “9”, “10”, “11” and “12” are arranged. The directions of the figures are also displayed in the second direction meeting the upward and downward direction.

In the foldable portable telephone 100A, when the second casing 2A is opened in the first direction and in the second direction respectively relative to the first casing 1A, printed characters of the operating portion 51A are arranged so as to be seen in directions suitable for the direction of a display of a liquid crystal display portion. Now, a detail of a structure thereof will be described below.

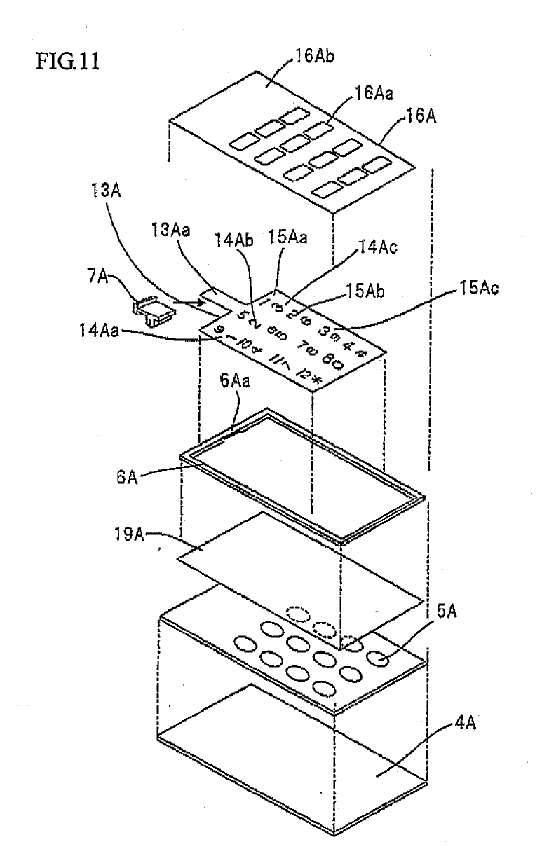

FIG. 11 is an exploded perspective view of main portions of the operating portion 51. As shown in FIG. 11, on a key sheet 13A, the contents of keys such as the figures are printed on its surface. The figures from “1” to “10” for the ten-key are arranged and printed in such a way as shown by 14Aa, 14Ab and 14Ac. Further, such figures for television channels as 15Aa, 15Ab and 5Ac and the figures for the ten-key are alternately arranged and printed. The directions of the figures for the ten-key (a first group of printed characters) are printed in the first direction of the second casing 2A as the upward and downward direction. The figures for the television channels (a second group of printed characters) are printed in the second direction by changing the angle of the first direction by an angle of 90 degrees. The key sheet 13A is made of a plastic sheet which is thin, however, has such a rigidity as not to be buckled. Then, as shown in FIG. 11, at an end thereof, a follower attaching portion 13Aa is formed protrude.

In a periphery of the key sheet 13A shown in FIG. 11, a frame 6A is arranged. In a back surface side (an opposite surface to a character printing surface), a pusher sheet 19A is arranged. The frame 6A is provided so as to surround the periphery of the key sheet in order to regulate the movement of the key sheet 13A. On a lower surface of the frame 6A, a stepped portion 6Aa is provided to reduce the thickness of the frame 6A so that the above-described follower attaching portion 13Aa of the key sheet 13A pass the stepped portion. To the lower surface of the frame 6A, the pusher sheet 19A is stuck and fixed to improve a sense of click of a key.

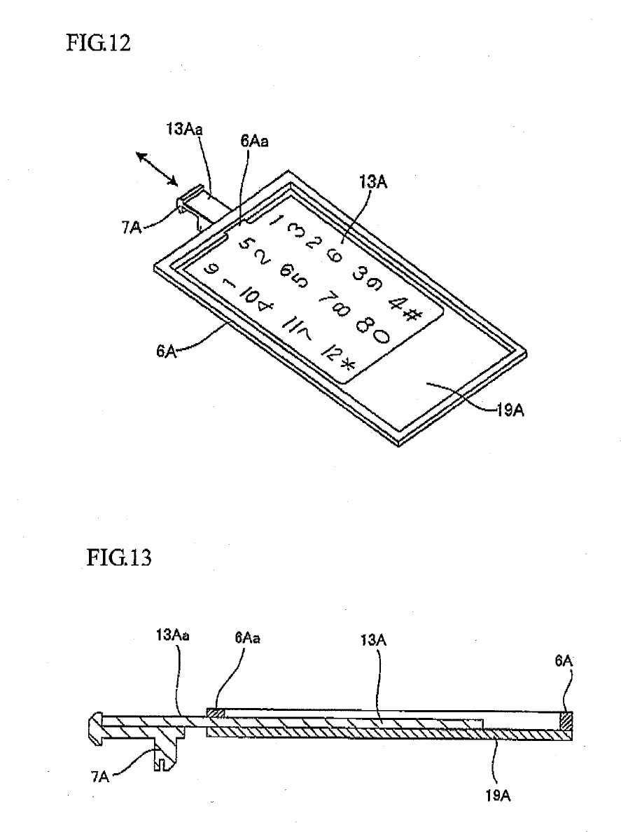

Under state that the pusher sheet 19A is stuck and fixed to the lower surface of the frame 6A, the key sheet 13A is placed on the pusher sheet 19A and the follower attaching portion 13Aa formed at one end of the key sheet 13A is allowed to pass through a space between the stepped portion 6Aa of the frame and the pusher sheet 19A to fix a follower 7A to the follower attaching portion 13Aa. FIG. 12 shows a perspective view of this state and FIG. 13 shows a sectional view.

Returning to FIG. 11, on a front surface side of the key sheet 13A, a key top sheet 16A made of a plastic member is overlaid or overlapped. On the key top sheet 16A, display windows 16Aa are formed with the sizes of the printed characters of the one group of printed characters and at intervals of printed characters so that only the prints of the first group of printed characters or the second group of printed characters in the key sheet 13A are seen, and a remaining portion 16Ab is formed to be opaque. The key top sheet 16A is stuck and fixed to an upper surface of the frame 6A. The key sheet 13A slides in a space sealed by the key top sheet 16A, the frame 6A and the pusher sheet 19A.

As described below, the follower member 7A moves following the protruding portion 12A attached to the first rotational axis 9A when the first rotational axis 9A moves at a prescribed angle or more relative thereto. Accordingly, the key sheet 13A to which the follower member 7A is fixed slides in the space formed by the frame 6A, the pusher sheet 19A and the key top sheet 16A following the rotation of the first rotational axis 9A,

In FIG. 11, In a lower portion of the frame 6A and the pusher sheet 19A, diaphragms SA and a key circuit board 4A are arranged. The number of the diaphragms 5A smaller than that of the figures and characters printed on the key sheet 13A are arranged. When the diaphragm 5A is pressed from an upper portion, a central portion is depressed and a contact provided at a position overlapped on the central portion comes into contact with a contact circuit for a key on the key circuit board 4A to be electrically conducted thereto so that a pressing operation is sensed.

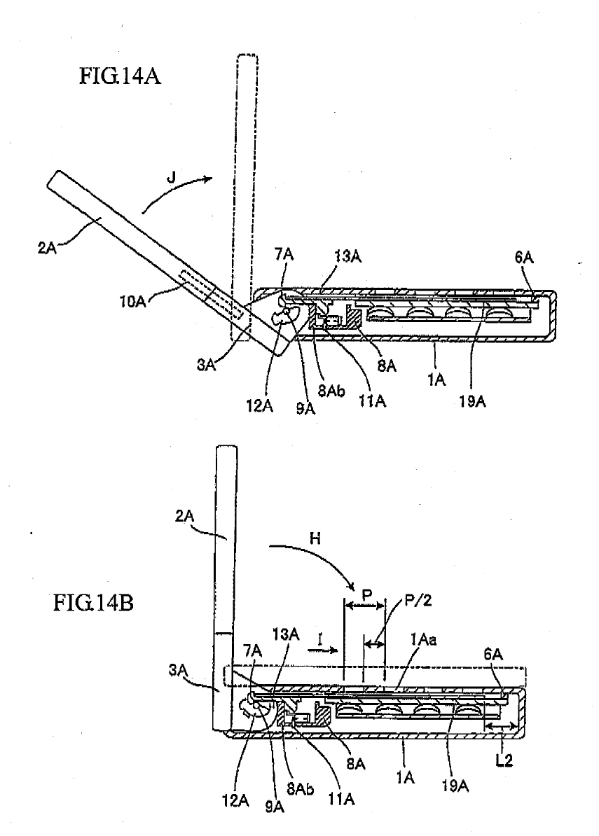

In FIG. 14A, a partial sectional view of the foldable portable telephone 100A according to the second exemplary embodiment of the present invention is shown that illustrates a state that the second casing 2A is closed to a position at an angle of 90 degrees from the opened state in the first direction.

In the first casing 1A, a torsion coil spring holder SA is provided to support a torsion coil spring 11A by a spring holder 8Aa to press an end face of the follower member 7A fixed to the key sheet 13A to the protruding portion 12A fixed to the first rotational axis 9A. The key sheet 13A is apt to move leftward in the drawing by the force of the torsion coil spring 11A. In a left end of the torsion coil spring holder 8A, a stopper portion 8Ab protrudes that stops the movement of the key sheet 13A in the leftward direction in the drawing. When there is not any other member for stopping the movement of the key sheet 13A, the key sheet 13A moves in the leftward direction in the drawing in the casing until the key sheet 13A abuts on the stopper portion 8Ab.

The protruding portion 12A is attached to the first rotational axis 9A. The protruding portion 12A abuts on the end of the follower member 7A fixed to the key sheet 13A, and slides and moves the key sheet 13A when the first rotational axis 9A rotates.

Under a state shown in FIG. 14A, the follower member 7A abuts on the stopper portion 8Ab formed to protrude on the torsion coil spring holder 8A and does not come into contact with the protruding portion 12A, however, when the second casing 2A is rotated in the first direction and closed, the follower member 7A comes into contact with the protruding portion 12A.

Since the protruding portion does not come into contact with the protruding portion 12A until the above-described operations, the key sheet is not moved. Thus, a state having an ordinary character representation suitable for a speech or reading an electronic mail as the portable telephone can be maintained.

In FIG. 14B, a state is shown that the second casing 2A is moved in the first direction so as to be closed from prescribed degrees. The first casing IA is shown in section. The connecting portion 3A is moved together with the second casing 2A in the first direction so as to be closed as shown by an arrow mark H relative to the first casing IA. When the connecting portion 3A is closed, the first rotational axis 9A fixed integrally to the connecting portion 3A is also rotated in the direction shown by the arrow mark H. When the first rotational axis 9A is rotated, the protruding portion 12A interlocks therewith to rotate. When the protruding portion 12A is rotated in the direction shown by the arrow mark H, the follower member 7A is moved rightward in the drawing, that is, in the direction shown by an arrow mark I by the force of the torsion coil spring 11A. The follower member 7A is continuously moved leftward in the drawing to abut and stop on the stopper portion 8Ab formed to protrude in the torsion coil spring holder 8A.

Thus, a user carries out an operation for closing the second casing so that the key sheet provided in the first casing is moved, however, the user does not need to feel that the characters are actually changed due to an interruption of the second casing.

An amount of movement of the follower member 7A is set to an amount half as long as one pitch between adjacent windows 1Aa of the first casing 1A. Namely, when the one pitch is supposed to be “P”, the follower member 7A is moved leftward by “P/2” and the key sheet 13A to which the follower member 7A is fixed is also moved leftward by “P/2”.

In the foldable portable telephone 100A of the present invention, when the second casing 2A is closed in the first direction to a prescribed angle, the movement of the follower member 7A by the protruding portion 12A is started. As a result, the arrangement of keys and the direction of the display of the operating portion 51 A are not changed until the second casing 2A is closed to 90 degrees in the first direction. When the second casing 2A begins to be closed in the first direction, the arrangement of the keys and the direction of the display of the operating portion begin to be changed. When the second casing is completely closed, the characters are completely changed.

Accordingly, in the second exemplary embodiment, an example is explained in which when the second casing 2A is closed in the first direction to 90 degrees, the arrangement of the keys and the direction of the display are started to change, however, an angle is not limited to 90 degrees.

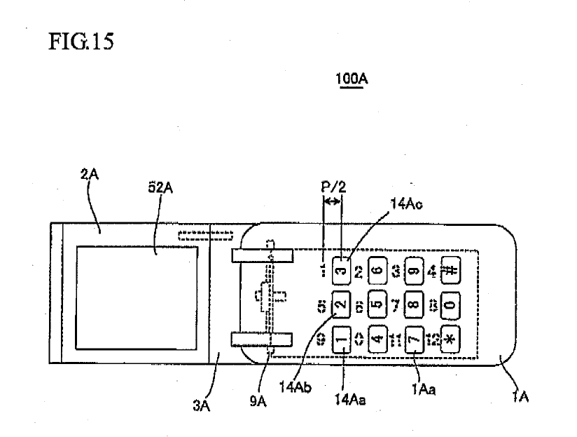

FIG. 15 shows a plan view of the foldable portable telephone 100A when the second casing 2A is completely opened in the first direction. Since the second casing 2A is opened together with the connecting portion 3A, for operating buttons, the figures can be seen from the transparent windows 1Aa of the first casing 1A, In FIG. 15, the figures are seen in such a way that “1”, “2” and “3” are arranged in a first stage on the direction of characters for a telephone. In a second stage, “4”, “5”, and “6” are arranged. Then, in a third stage, “7”, “8” and “9” are arranged. In a fourth stage, “*”, “0” and “#” are arranged. Consequently, when the display portion 52A of the foldable portable telephone 100A is set to a longitudinally long form, the user Can push ten-key buttons as the arrangement of the figures of the telephone without a hesitation.

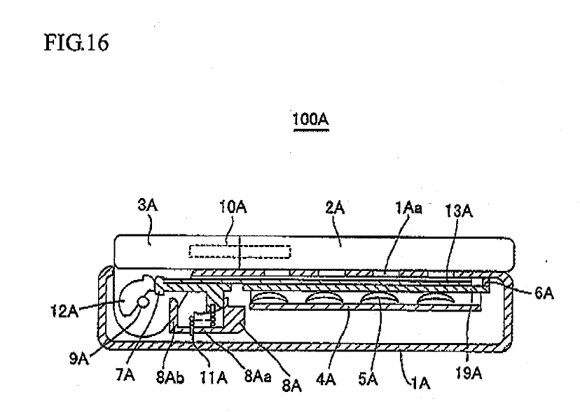

FIG. 16 shows a state that the second casing 2A is closed together with the connecting portion 3A relative to the first casing 1A and shows an inner portion of the first casing 1A in section. In the first casing 1, the printed circuit board 4A is provided that is supported by a support portion not shown in the drawing. On the printed circuit board 4A, are arranged the diaphragms 5A the number of which is smaller than that of the figures and characters printed on the key sheet 13A. On the diaphragms 5A, the pusher sheet 19A is fixed, In the drawing, the frame 6A and the pusher sheet 19A are exaggeratedly drawn so that the sectional forms of the frame 16A and the pusher sheet 19A are clearly seen. However, an actual thickness of an entire portion is small. When the pusher sheet 19A is pressed from an upper portion, the pusher sheet is bent to depress the central portion of the diaphragm 5A immediately below the pusher sheet 19A.

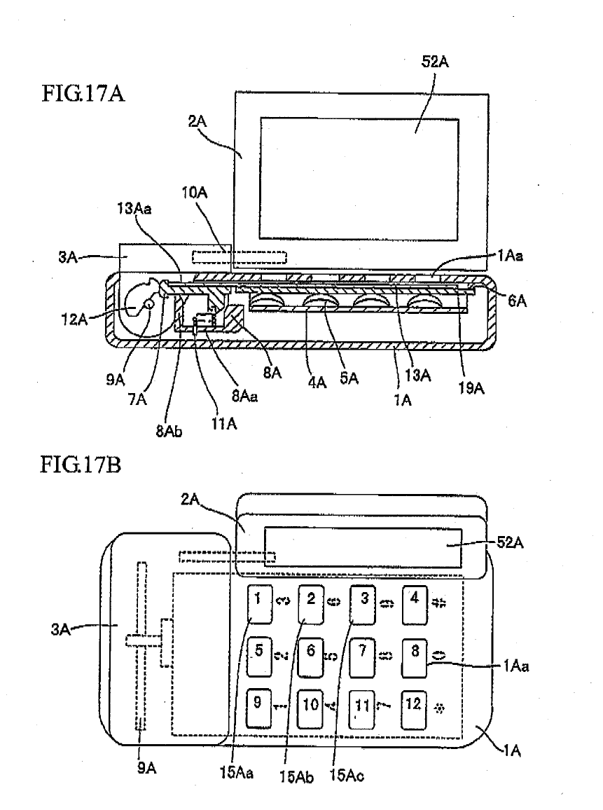

FIG. 17A shows a state that the second casing 2A is opened in the second direction. The first easing IA is shown in section. The connecting portion 3A remains to be closed relative to the first casing IA, however, the second casing 2A is rotated on the second rotational axis 10A to show the display portion 52A. Here, since the connecting portion 3A remains to be closed relative to the first casing 1A, the first rotational axis 9A does not rotate. Namely, the protruding portion 12A does not rotate and the position of the key sheet 13A is the same as that when the second casing 2A is closed as shown in FIG. 14.

FIG. 17B shows a plan view of the foldable portable telephone 100A when the second casing 2A is opened in the second direction. Since the second casing 2A is opened, for the operating buttons, the figures can be seen from the display windows IAa of the first casing 1A. In FIG. 17B, the figures from “1” to “12” for the television channels are seen in such a way that “1”, “2”, “3” and “4” are arranged in a first stage on the direction of characters. In a second stage, “5”, “6”, “7” and “8” are arranged. In a third stage, “9”, “10”, “11” and “12” are arranged. Consequently, when the display portion 52A of the foldable portable telephone 100A is set to a horizontally long form to see a television broadcast, the user can push any of channels of “1” to “12” without a hesitation.

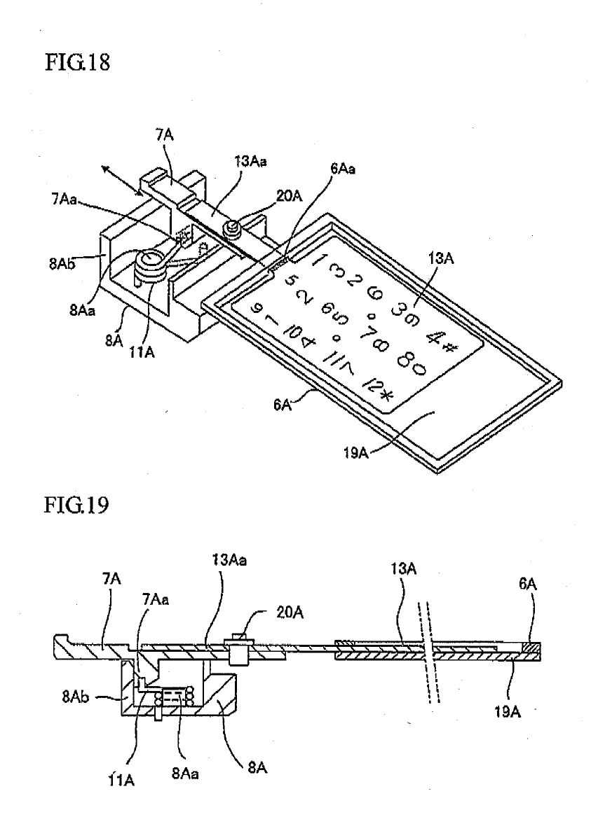

FIG. 18 is a perspective view showing a state that the frame 6A and the pusher sheet 19A are formed integrally, then, the key sheet 13A is placed on the pusher sheet 9A, and the follower attaching portion 13Aa is allowed to pass through the space formed by the stepped portion 6Aa of the frame and the pusher sheet 19A to fix the follower 7A to the follower attaching portion 13Aa and engage the follower 7A with the torsion coil spring 11A.

FIG. 19 shows a sectional view of FIG. 18. As shown in FIG. 19, in a lower portion of the follower 7A, a groove 7Aa is formed to be engaged with an end portion of the torsion coil spring 11A. The torsion coil spring 11A is attached to the torsion coil spring holder 8A. In the torsion coil spring holder 8A, a holder 8Aa and the stopper 8Ab having the same functions as those shown in FIG. 14.

Further, the end portion of the torsion coil spring 11A shifts in the form of a circular arc, however, slides in the direction of the grove 7Aa in the lower portion of the follower 7A. Further, in the second exemplary embodiment of the present invention, as a unit for fixing the key sheet 13A and the follower 7A, a guide pin 20A is fitted to the flower 7A from an upper portion of the follower attaching portion 13Aa of the key sheet 13A. Then, the guide pin 20A is allowed to abut on a guide groove not shown in the drawing that is provided in the first casing 1A in the sliding direction. When the key sheet 13A slides, its sliding movement is regulated so that the key sheet does not move in the direction orthogonal to the sliding direction. In such a way, since the sliding movement of the key sheet 13A is regulated by the guide pin 20A and the guide groove not show in the drawing that is provided in the first casing in the sliding direction, the key sheet 13A moves only in the sliding direction. As a result, the key sheet 13A slides in a stable way.

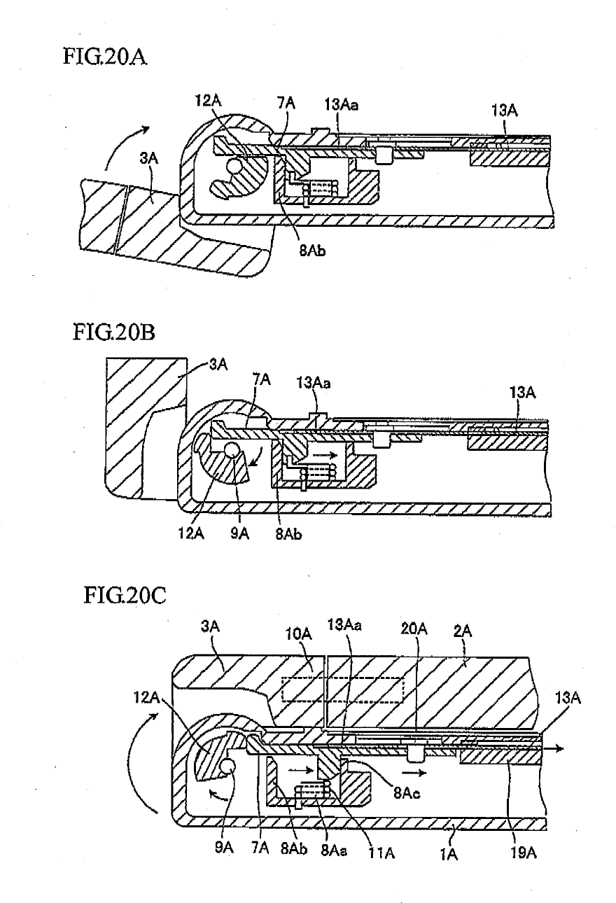

FIGS. 20A to 20C show a detail of a partial sectional view illustrating the sliding state of the key sheet 13A when the second casing 2A is opened and closed together with the connecting portion 3A relative t the first casing 1A as shown in FIG. 14.

FIG. 20A shows a sectional view of a state that the second casing 2A and the connecting portion 3A are completely opened, FIG. 20B shows a sectional view of a state that the second casing 2A and the connecting portion 3A are opened at 90 degrees. FIG. 20C shows a partial sectional view when the second casing 2A is closed together with the connecting portion 3A relative to the first casing 1A.

In the above-described second exemplary embodiment, a case is described that the protruding portion 12A is fixed to the first rotational axis 9A. However, in a structure that the rotation of the first rotational axis 9A interlocks with the protruding portion 12A and is transmitted to the protruding portion 12A, any other structure may be used. For instance, another shaft may be provided between the first rotational axis 9A and an axis of the protruding portion 12A to allow the first rotational axis 9A and the protruding portion 12A to interlock with each other. Thus, the position of the axis of the protruding portion 12A may be arbitrarily set.

Further, the rotating movement of the connecting portion 3A as the third casing relative to the first casing 1A is taken as the movement of the protruding portion 12A to slide the key sheet 13A to which the follower member 7A is fixed, so that the contents of the display and the direction of the display of the operating portion are mechanically changed. Therefore, even when a power is not turned on in a portable terminal device, the contents of the display and the direction of the display of the operating portion can be assuredly changed.

Further, as described above, the portable telephone having a television receiving unit is explained as one of the portable terminal device. In a portable telephone having a game function, when the casing is opened in the second direction, the arrangement of keys may be changed to the arrangement of keys for a game so as to be used as a game machine. In addition thereto, characters displayed in two different directions may be alternately arranged.

Further, as the arrangement of characters displayed when the second casing is opened in the second direction relative to the first casing, the figures are seen in such a way that that “1”, “2”, “3” and “4” are arranged in a first stage. In a second stage, “5”, “6”, “7” and “8” are arranged. Then, in a third stage, “9”, “10”, “11” and “12” are arranged. However, in order to input a mail without an uneasiness, “1”, “2” and “3” may be arranged in the first stage from an upper portion in the direction of characters, “4”, “5” and “6” may be arranged in the second stage and “7”, “8” and “9” may be arranged in the third stage.

Further, as a standard for ensuring a positional accuracy of the key sheet 13A, in the specification, the accuracy is ensured by allowing the key sheet 13A to come into contact with the stopper portion 8Ab. However, a structure may be formed in which the key sheet 13A may be allowed to abut on an end face inside to obtain the positional accuracy.

### Third Exemplary Embodiment

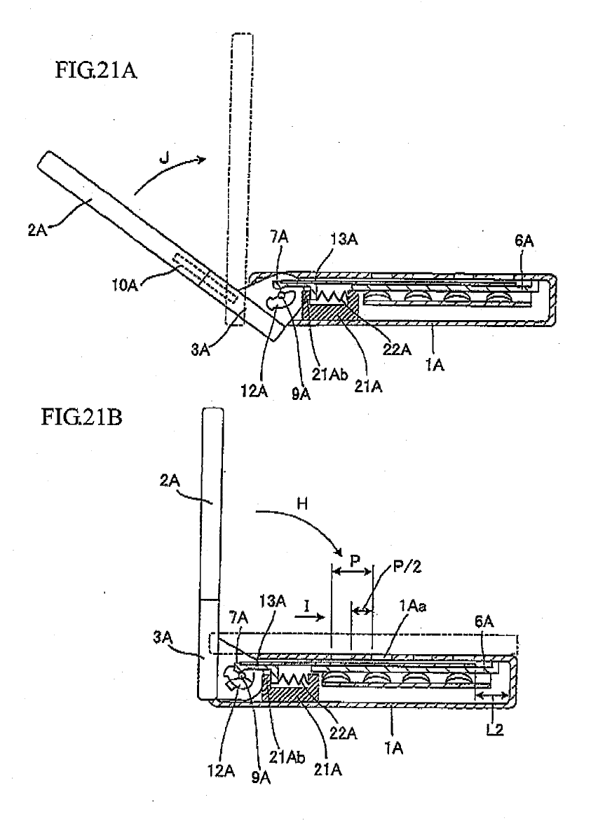

FIG. 21 shows a partial sectional view of a foldable portable telephone 100A according to a third exemplary embodiment of the present invention. In FIG. 21, in a first casing 1A, a compressed spring holder 21A is provided to support a compressed spring 22A by the compressed spring holder 21A and press an end face of a follower member 7A fixed to a key sheet 13A to a protrusion 12A fixed to a first rotational axis. The structure of the third exemplary embodiment is merely different from that of the second exemplary embodiment in view of a point that the compressed spring is used in place of the torsion coil spring as a kind of spring, and other structures are the same as those of the second exemplary embodiment.

### Fourth Exemplary Embodiment

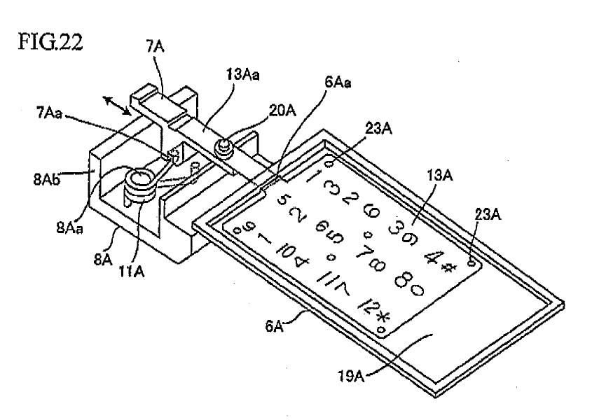

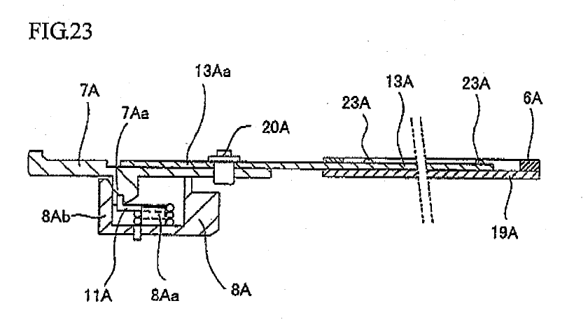

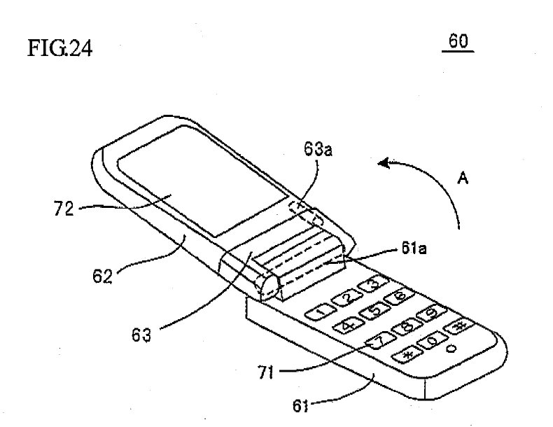

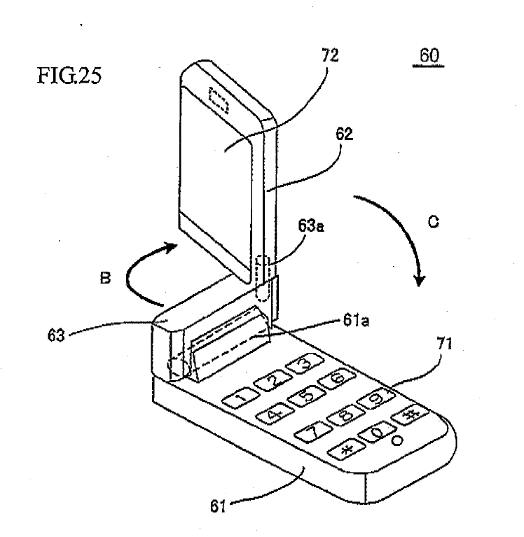

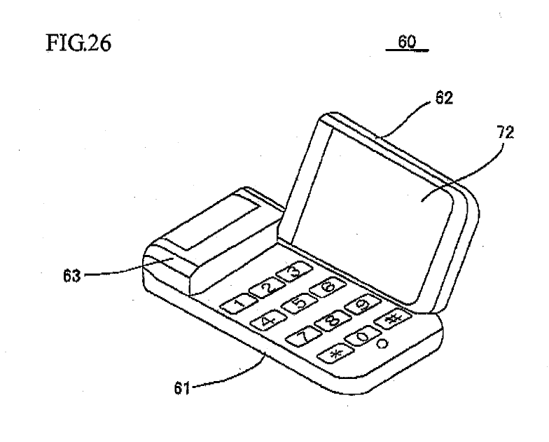

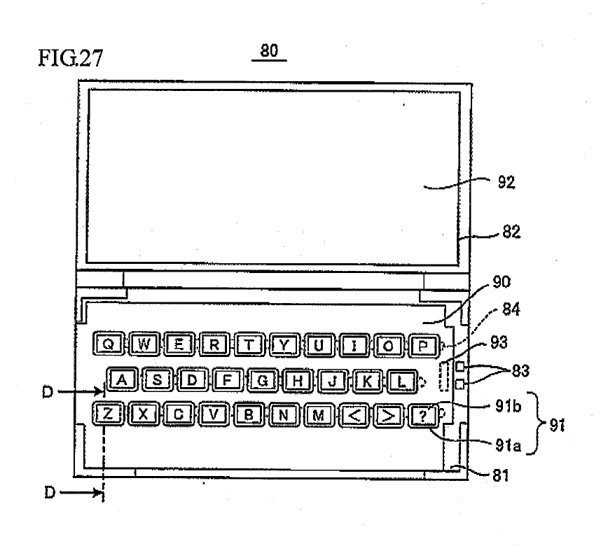

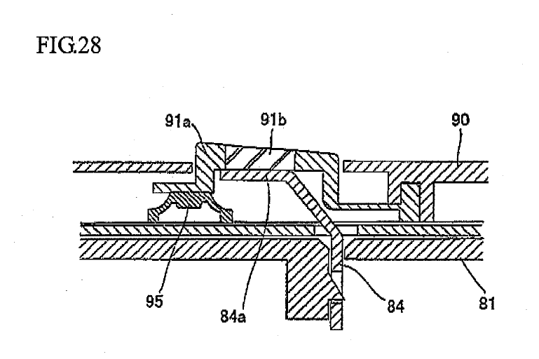

Now, a fourth exemplary embodiment of the present invention will be described by referring to FIG. 22 and FIG. 23. The fourth exemplary embodiment is characterized in that micro protrusions 23A are formed on a surface of a key sheet 13A, and other structures are the same as those of the second exemplary embodiment. The micro protrusions are provided on the surface so that a prescribed space may be maintained between a key top sheet and the key sheet. Since a contact area can be reduced, a sliding resistance can be reduced.

An example is shown in which the micro protrusions 23A are provided at several portions, however, many micro protrusions 23A may be provided. The micro protrusions may be provided not on the front surface, but also on a back surface. Further, the protruding height of the micro protrusion 23A may be smaller than the thickness of the key sheet 13A.

The present invention is described in detail by referring to the specific exemplary embodiments, however it is to be understood to a person with ordinary skill in the art that various changes or modifications may be made without departing from the spirit and the scope of the present invention.

This application is based on Japanese Patent Application (JPA No. 2007-238806) filed on Sep. 14, 2007 and Japanese Patent Application (SPA No. 2008-018696) filed on Jan. 30, 2008, and the contents thereof are incorporated herein as a reference.

### INDUSTRIAL APPLICABILITY

The present invention may be applied to a folding mobile terminal having two rotational axes and connected so as to be opened and closed in a longitudinal direction and in a transverse direction not only in a foldable portable telephone, but also in a game machine used by changing a display screen in a longitudinal direction and in a transverse direction or a PDA having a television receiving function.

1. A folding mobile terminal comprising a first casing provided with an operating portion and a second casing provided with a display, the first and the second casings connected through a connecting portion, characterized in that:
the connecting portion comprises:
a first rotational axis opening and closing the second casing in a longitudinal direction relative to the first casing; and
a second rotational axis opening and closing the second casing in a transverse direction relative to the first casing, and
the operating portion comprises;
a key sheet printed with contents of respective operation keys,
wherein the key sheet slides while following the rotation of the first rotational axis and the key sheet does not follow the rotation of the second rotational axis.

2. A folding mobile terminal comprising a first casing provided with an operating portion and a second casing provided with a display, the first and the second casings connected through a connecting portion, characterized in that:
the connecting portion comprises:
a first rotational axis opening and closing the second casing in a longitudinal direction relative to the first casing;
a second rotational axis opening and closing the second casing in a transverse direction relative to the first casing; and
a cam attached to the first rotational axis,
the first casing comprises inside thereof:
a key sheet printed with contents of operation keys; and
a follower member fixed to the key sheet and following the rotation of the cam,
wherein the follower member and the key sheet slide while following the cam when the first rotational axis rotates.

3. The folding mobile terminal according to claim 2, wherein
the follower member is urged by a compressed spring toward the connecting portion on which the cam is arranged in the longitudinal direction;
the follower member abuts on the cam while the first casing and the second casing are in a closed state; and
the follower member moves toward the connecting portion while following the cam by urging of the compressed spring when the cam rotates in accordance with the rotation of the first rotational axis from the closed state.

4. The folding mobile terminal according to claim 3, wherein one end of the compressed spring is attached to the follower member, and the other end of the compressed spring is fixed to a holder provided inside of the first casing.

5. The folding mobile terminal according to claim 1, comprising:
a mask sheet overlapping a printed surface side of the key sheet, wherein
a first character group is printed on the printed surface of the key sheet in the longitudinal direction of the first casing and a second character group is printed on the printed surface of the key sheet in the transverse direction of the first casing,
the mask sheet forms a plurality of transparent display windows through which either the first character group or the second character group is externally and visually recognizable when the slide sheet slides,
the first character group overlaps the display windows while the second casing is in a opened state relative to the first casing in the longitudinal direction, the second character group overlaps on the display windows while the second casing is in a opened state or in a closed state relative to the first casing in the transverse direction.

6. A folding mobile terminal comprising a first casing provided with an operating portion and a second casing provided with a display, the first and the second casings connected through a connecting portion, characterized in that:
the connecting portion comprises:
a first rotational axis for rotating the second casing relative to the first casing in a first direction; and
a second rotational axis for rotating the second casing relative to the first casing in a second direction perpendicular to the first direction; and
the operating portion comprises:
a key sheet printed with characters showing functions of respective keys; a key top sheet disposed on a printed surface side of the key sheet;
a frame surrounding the key sheet; and
a pusher sheet disposed on a back surface side of the printed surface of the key sheet and fixed to the frame,
wherein the key sheet is fixed to a connecting member which interlocks with the rotation of the first rotational axis, and the key sheet slides inside of the frame in accordance with the rotation of the first rotational axis.

7. The folding mobile terminal according to claim 6, wherein the first direction is a longitudinal direction in which the second casing is opened relative to the first casing, and the second direction is a transverse direction in which the second casing is opened relative to the first casing.

8. The folding mobile terminal according to claim 6, wherein the pusher sheet are stuck and fixed to the frame.

9. The folding mobile terminal according to claim 6, wherein the key top sheet are stuck and fixed to the frame.

10. The folding mobile terminal according to claim 6, wherein the connecting member comprises:
a protrusion fixed to the first rotational axis, which rotates in accordance with the rotation of the first rotational axis; and
a follower member fixed at one end thereof to the key sheet, which follows the protrusion at the other end thereof when the first rotational axis rotates in a predetermined angle,
wherein when the second casing rotates about the first rotational axis for a closing direction, and the key sheet slides by the rotation of the protrusion so as to push the other end of the follower member.

11. The folding mobile terminal according to claim 6, wherein
the key sheet is printed with a first character group in a first direction and with a second character group in a second direction perpendicular to the first direction;
the key top sheet forms a plurality of transparent display windows through which either the first character group or the second character group is externally and visually recognizable, when the key sheet slides;
the first character group overlaps on the display window when the second casing is in an opened state in the first direction relative to the first casing; and
the second character group overlaps on the display window when the second casing is in an opened state in the second direction relative to the first casing or in a closed state.

12. The folding mobile terminal according to claim 6, wherein the characters displayed on the key sheet in two different directs are alternately printed.

13. The folding mobile terminal according to claim 6, comprising:
a radio communication unit and a television broadcast receiving unit, wherein characters for the radio communication are printed as the first character group; and character for the television broadcast receiving are printed as the second character group.

14. The folding mobile terminal according to claim 6, comprising:
a pressing unit, whose one end is fixed to the follower member and the other end is fixed to a supporting portion provided inside of the first casing, wherein
the follower member is pressed toward the connecting portion in the first direction by the pressing unit;
the follower member abuts on the protrusion when the first casing and the second casing are in the closed state;
the follower member moves toward the connecting portion following the protrusion under the pressure from the pressing unit when the protrusion rotates in accordance with the rotation of the first rotational axis from the closed state.

15. The folding mobile terminal according to claim 14, wherein the pressing unit is a torsion coil spring.

16. The folding mobile terminal according to claim 14, wherein the pressing unit is a compressed spring.

17. The folding mobile terminal according to claim 14, wherein a stopper is formed on the holder in a direction of the follower member movement; and
the follower member abuts on the stopper when the follower member moves in a predetermined amount.

18. The folding mobile terminal according to claim 6, wherein a plurality of micro protrusions are formed on the printed surface of the key sheet.
